(19) United States
(12) Patent Application Publication
(10) Pub. No.: US 2021/0054270 A1
(43) Pub. Date: Feb. 25, 2021

(54) Emitter for trace samples of nickel isotope analysis and its application in thermal ionization mass spectrometry

(71) Applicant: Institute of Geology and Geophysics, Chinese Academy of Sciences, Beijing (CN)

(72) Inventor: Chaofeng Li, Beijing (CN)

(73) Assignee: Institute of Geology and Geophysics, Chinese Academy of Sciences

(21) Appl. No.: 17/090,891

(22) Filed: Nov. 6, 2020

(30) Foreign Application Priority Data
Nov. 28, 2019 (CN) 201911189314X

(51) Int. Cl. C09K 11/70; H01J 49/16

(52) U.S. Cl. CPC C09K 11/70; H01J 49/16

(57) ABSTRACT

An emitter for nickel isotope analysis of trace samples, its preparation and application are provided, wherein: the emitter is a zirconium hydrogen phosphate emitter; and the zirconium hydrogen phosphate emitter specifically comprises a zirconium hydrogen phosphate suspension and phosphoric acid solution as an auxiliary material. To prepare the zirconium hydrogen phosphate suspension, the zirconium hydrogen phosphate powder must be washed alternately with hydrochloric acid and high-purity water 3 to 4 times to reduce the sample loading blank. The application specifically relates to analytical method, specifically using zirconium hydrogen phosphate suspension as a high-sensitivity emitter to enhance the ionization efficiency of nickel samples, while using phosphoric acid solution to assist ionization, and using high-purity tungsten filament as the sample carrier to determine trace nickel isotope method.

### CROSS REFERENCE OF RELATED APPLICATION

The present application claims priority under 35 U.S.C. 119(a-d) to CN 201911189314.X, filed Nov. 28, 2019.

### BACKGROUND OF THE PRESENT INVENTION

### Field of Invention

The present invention relates to the technical field of analytical chemistry, and particular to an emitter for trace samples of nickel isotope analysis and its application in thermal ionization mass spectrometry.

### Description of Related Arts

Nickel, belonging to the iron group element, has five natural isotopes of ⁵⁸Ni, ⁶⁰Ni, ⁶¹Ni, ⁶²Ni, and ⁶⁴Ni, with abundances of 68.077%, 26.223%, 1.140%, 3.635% and 0.926%, respectively. The geochemical properties of nickel are characterized by strong iron affinity and strong sulfur affinity. Nickel is mainly enriched in mafic and ultra-mafic rocks, and extremely enriched in sulfide minerals. The distribution of nickel is rapidly increased from the earth crust to the earth core. For a long time, the early evolution of the solar system and the early evolution of life on the Earth have been frontier scientific issues in geochemistry and astrochemistry. Nickel isotopes play an important role in studying these issues in geochemistry and astrochemistry.

As for early solar system evolution, the ⁶⁰Fe—⁶⁰Ni extinct nuclide isotope system is an indispensable isotope clock for early evolution dating. Compared with the long half-life ⁸⁷Rb—⁸⁷Sr and ¹⁴⁷Sm—¹⁴³Nd isotopic systems, which are the most widely used in earth science research, ⁶⁰Fe has a shorter half-life of 2.62 million years, and ⁶⁰Fe decays ⁶⁰Ni through β⁻ decay. The ⁶⁰Fe—⁶⁰Ni extinct nuclide system can be adopted as an accurate isotope time scale to study the early evolution history (<15 Ma) of terrestrial planets in the solar system, so as to determine the age of early events in the solar system and to accurately trace the evolution of early terrestrial planets process.

The “Great Oxidation Event” is one of the most significant events in the Earth's history, which not only changed the environment on the Earth's surface, but also changed the subsequent ocean chemical evolution conditions and the way of element cycling. This period, 2.3-2.7 billion years ago, is also the key to the evolution of early life on Earth. Therefore, researches on the “great oxidation event” have always been the frontier of earth science research. At present, most scientists believe that the significant decrease of the content of methane in the atmosphere may triggered the continuous increase of oxygen in the atmosphere in 2.4 billion years ago, hence leading to a “major oxidation event” and ultimately promoting the evolution of early life on Earth. However, there are still many controversies about the specific time, conditions and evolution model of the “great oxidation event”. Since Ni is the most important catalyst among the many enzymes of methanogens, it is an important factor affecting the methane production rate during the earth history period. Studies have shown that the decrease of Ni concentration will cause the rapid decline of methane production, thus triggering the increase of the oxygen production. Therefore, the study of the characteristics and fractionation mechanism of nickel isotopes in Archean sediments has extremely important application value for studying the “great oxidation events” and early life evolution.

In summary, no matter for the evolution of early solar system or the evolution of early life on Earth, Ni isotope is an important isotope probe. The prerequisite of Ni isotope application is to achieve high-precision ⁶⁰Ni/⁵⁸Ni isotope ratio. The internal precision of a single analysis is generally better than 0.003% (1RSE), and the external accuracy of long-term determination is generally better than 0.006% (1RSD). At present, there are two types of instruments that can provide high-precision isotope determination, thermal ionization mass spectrometry (TIMS) and multiple-collector inductively coupled plasma mass spectrometry (MC-ICP-MS). Both TIMS and MC-ICP-MS have their own advantages for isotope determination. In general, MC-ICP-MS has higher sensitivity, higher analysis efficiency, and higher ionization efficiency for elements with a first ionization potential greater than 7 eV that are difficult to be ionized. However, strong memory effects, complex molecular ion peak interferences and secondary ion background interferences are the main bottlenecks that plague MC-ICP-MS analysis. Especially for the analysis of trace samples, the impact of these interferences is particularly serious. “Low memory effect” and “Selective ionization character” are the outstanding advantages of TIMS, so TIMS is usually the best choice for isotope analysis of trace samples, especially for classic isotope systems of Rb—Sr, Sm—Nd, U—Pb and Re—Os.

However, so far, almost all published articles employ MC-ICP-MS as analytical instrument to determine nickel isotope. The main reason is that nickel cannot be effectively ionized on TIMS so as to afford a poor analytical precision. Because nickel has a high ionization potential of 7.64 eV, a high melting point of 1455 degrees and a high work function of 5.22 eV, high-purity nickel wire is even one of the commonly used filament materials on TIMS and is often used as a sample carrier to ionize other elements. Therefore, it is extremely difficult for nickel to be effectively ionized on the TIMS, and the ionization efficiency of Ni is low, especially for the sample size below 1 microgram, it is difficult to achieve high-precision Ni isotope ratio data. A few existing application studies that employ TIMS to determine Ni isotopes show that a sample size of 2 to 5 micrograms is generally consumed at each analysis.

The key for nickel isotope technology using TIMS lies in the development of highly sensitive emitters. The emitters are the core materials to enhance the ionization efficiency of Ni samples and are the prerequisite for high-precision Ni isotope analysis.

The final of analytical sensitivity and accuracy of Ni isotope during TIMS measurement mainly depended on emitters and filament materials. So far, only two types of emitters are reported. Both of these emitters use silica gel as the main ingredient: 1. silica gel+boric acid+aluminum nitrate; 2. silica gel+phosphoric acid+aluminum chloride. However, the sensitivity of these two emitters is poor, so that each analysis consumes a large sample amount (1-10 μg), and the large sample analysis amount greatly restricts the application of nickel isotope in earth science and astrochemistry. Especially for some precious samples (such as meteorites, fossils) or samples with low nickel concentration, such as carbonate rocks, water samples and biological samples, the analytical accuracy is poor due to the inability to provide sufficient samples, which cannot meet the needs of scientific research.

In summary, so far, no highly sensitivity emitter for nickel isotope in small sample sizes (<1 μg) has been developed and reported. Therefore, it is urgent to develop the high-sensitivity emitter for nickel isotope analysis technology.

### SUMMARY OF THE PRESENT INVENTION

The technical problem to be solved by the present invention is to provide a high-sensitivity emitter suitable for high-precision nickel isotope analysis of small sample size, which is used to optimize the existing nickel isotope analytical technology based on thermal ionization mass spectrometry.

In order to solve the above technical problems, the present invention adopts the technical solutions as follows:

An emitter for small samples of nickel isotope analysis, wherein:
the emitter is a zirconium hydrogen phosphate powder; and
the zirconium hydrogen phosphate emitter specifically comprises a zirconium hydrogen phosphate suspension and phosphoric acid solution as an auxiliary material.

It should be noted that solid zirconium hydrogen phosphate powder generally cannot be directly coated, so it is generally loaded on the sample carrier (the present invention uses high-purity tungsten filament) in the form of a suspension, and dilute phosphoric acid is further added. On the one hand, dilute phosphoric acid is used as an adhesive and can make the zirconium hydrogen phosphate emitter better coated and firmly fixed on the surface of the filament. On the other hand, it can also appropriately enhance the ionization efficiency of the sample.

Furthermore, the zirconium hydrogen phosphate suspension is prepared by the following process: first alternately washing the high-purity zirconium phosphate powder by hydrochloric acid and high-purity deionized water 3 to 4 times to reduce loading blank; then adding deionized water to obtain zirconium hydrogen phosphate suspension.

Furthermore, a concentration of the zirconium hydrogen phosphate suspension is converted according to a dosage of the zirconium hydrogen phosphate emitter required for each analysis and a loading amount of the zirconium hydrogen phosphate suspension, specifically, the dosage of the high-purity zirconium hydrogen phosphate powder required for each test is 30±0.2 μg, and the loading size of the zirconium hydrogen phosphate suspension is 1 to 3 μL, so the concentration of the zirconium hydrogen phosphate suspension is at a range of 10 to 30 mg/mL.

The concentration of zirconium hydrogen phosphate suspension in the present invention mainly depends on the dosage of zirconium hydrogen phosphate emitter. Generally, the dosage of high-purity zirconium hydrogen phosphate powder required for each analysis is 30±0.2 μg, and the maximum cannot be greater than 40 micrograms. Otherwise it will significantly affect the determination of nickel samples, such as the following problems: 1. The sample falls off. 2. The ion lens is contaminated. 3. The signal emission is unstable. A preferred emitter dose of the present invention is 30±0.2 μg.

In addition, if the sample volume of the zirconium hydrogen phosphate suspension is too large for each analysis, the sample will evaporate slowly and give rise of a risk of sample diffusion. Therefore, the sample volume of each zirconium hydrogen phosphate suspension is generally controlled at 1 μL. The maximum volume should not exceed 3 μL, so the corresponding concentration of zirconium hydrogen phosphate is generally 10-30 mg/mL, specifically based on the dose of zirconium hydrogen phosphate emitter required for each analysis and the loading amount of zirconium hydrogen phosphate suspension.

Preferably, a purity of the high-purity zirconium hydrogen phosphate powder is higher than 99.9%;

Preferably, a particle size of the high-purity zirconium hydrogen phosphate powder is less than 75 μm. That is generally able to pass a 200 mesh sieve.

Preferably, the concentration of the phosphoric acid solution is 0.8-1.0 mol/L.

The present invention further provides a method for preparing an emitter for trace samples o nickel isotope analysis, wherein the emitter is a zirconium hydrogen phosphate powder; and the zirconium hydrogen phosphate emitter specifically comprises a zirconium hydrogen phosphate suspension and phosphoric acid solution as an auxiliary material;

### (1) A Preparation Method of the Zirconium Hydrogen Phosphate Suspension Comprising Steps of:

S1: pre-treating zirconium hydrogen phosphate, comprising:

S11: weighing the high-purity zirconium hydrogen phosphate powder and placing in a teflon vial, adding hydrochloric acid in proportion, closing the container and placing on a hot plate at 80-100 degrees for 1 to 2 hours, shaking the teflon vial and cleaning the zirconium hydrogen phosphate powder with hydrochloric acid to reduce the blank of sample loading;

S12: then, cooling to room temperature, taking out an upper layer of hydrochloric acid solution, adding high-purity deionized water, closing again and shaking the vial for 3 to 4 minutes, standing for layering, and then taking out the supernatant again;

S13: repeating the cleaning process of steps S11 and S12 for 3 to 4 times, and finally obtaining a precipitation phase, which is the pretreated zirconium hydrogen phosphate;

S2: weighing the zirconium hydrogen phosphate pretreated in step S13 and adding deionized water to prepare a zirconium hydrogen phosphate suspension of a certain concentration; wherein the concentration of the zirconium hydrogen phosphate suspension is based on the dosage of zirconium hydrogen phosphate emitter required for each analysis and the loading volume of zirconium hydrogen phosphate suspension; specifically, the dosage of high-purity zirconium hydrogen phosphate powder required for each analysis is 30±0.2 μg, and the loading volume of zirconium phosphate suspension is 1-3 μL; the concentration of the zirconium hydrogen phosphate suspension is 10-30 mg/mL;

The vial in the above pretreatment process is generally a teflon sample dissolver.

### (2) Preparing Phosphoric Acid Solution

weighing the concentrated phosphoric acid solution, adding deionized water in proportion to prepare a phosphoric acid solution with a concentration of 0.8-1.0 mol/L.

Generally, saturated phosphoric acid with a concentration of 14.63 mol/L is added to deionized water to prepare a phosphoric acid solution with a concentration of 0.8-1.0 mol/L.

Furthermore, in step S11, the concentration of hydrochloric acid for cleaning is 2 to 4 mol/L, and the amount of hydrochloric acid for cleaning is 1 ml per (30±0.2 mg) high-purity zirconium hydrogen phosphate powder;
in step S12, the amount of high-purity deionized water used for cleaning is 1 ml per (30±0.2 mg) high-purity zirconium hydrogen phosphate powder.

The present invention further provides a method for determining nickel isotopes of trace samples, which is characterized in adopting zirconium hydrogen phosphate suspension as a high-sensitivity emitter to enhance the ionization efficiency of nickel samples, and meanwhile adopting phosphoric acid solution to assist sample ionization, and adopting high-purity tungsten filament as a sample carrier to determine trace nickel isotopes.

Furthermore, the method for determining nickel isotopes in trace samples specifically comprises the following steps:

(1) taking an appropriate amount of the emitter composed of zirconium hydrogen phosphate suspension and phosphoric acid solution and coating on the surface of the high-purity tungsten filament; after the emitter evaporates to dryness, loading the nickel sample on the surface of the filament, and tuning the current to 2.2 amperes and evaporating nickel sample to dryness, then continuing to increase the filament current until the filament turns a dull red glow for 3 to 5 seconds, and then returning the current to zero;

(2) installing sample magazine into the thermal ionization mass spectrometer, and using the thermal ionization mass spectrometer to obtain high-precision nickel isotope data.

It is worth noting that when sample loading, the zirconium hydrogen phosphate emitter must be loaded on the surface of the high-purity tungsten filament.

Further, there are two loading manners available when the emitter is actually loaded on the surface of the tungsten filament. The first loading manner is that the prepared zirconium hydrogen phosphate suspension and the phosphoric acid solution are mixed to form a mixed solution in a teflon vial before coating on the filament. The second loading manner is that firstly loading phosphoric acid solution on the filament, after dryness of phosphoric acid, then followed by applying the zirconium hydrogen phosphate suspension. The first loading manner may probably lead to unstable analytical performance for Ni isotope analysis. This is because zirconium hydrogen phosphate and phosphate may undergo a slow chemical reaction and become other substances before loading as so to affect the final ionization efficiency of Ni sample. Therefore, it is generally used to load dilute phosphoric acid first and then load the zirconium hydrogen phosphate suspension. Generally, the analytical sensitivity using directly mixing manner of dilute phosphoric acid and zirconium hydrogen phosphate is not as good as the manner of two individual loading (first phosphoric acid and then zirconium hydrogen phosphate suspension).

Therefore, it is preferable to load the phosphoric acid solution first, and then load the zirconium hydrogen phosphate suspension on the filament.

Specifically, the step (1) coating process of the emitter is specifically as follows:

Take 1˜2 μL of phosphoric acid solution with a concentration of 0.8-1.0 mol/L and apply it on the surface of high-purity tungsten filament, tune the filament current to evaporate the phosphoric acid solution to dryness, and then take 1˜3 μL of a certain concentration of zirconium hydrogen phosphate suspension to cover onto the evaporated phosphoric acid coating, after the zirconium hydrogen phosphate suspension is evaporated to dryness, the nickel sample is loaded on the surface of the filament.

Specifically, the concentration of the zirconium hydrogen phosphate suspension is converted according to the dosage of the zirconium hydrogen phosphate emitter required for each analysis and the loading amount of the zirconium hydrogen phosphate suspension. Specifically, the high-purity zirconium hydrogen phosphate required for each analysis. The powder dosage is 30±0.2 μg, and the loading size of the zirconium hydrogen phosphate suspension is 1 to 3 μL, so the corresponding concentration of the zirconium hydrogen phosphate suspension is 10 to 30 mg/mL; The dosage of the reagent and the loading amount of the zirconium hydrogen phosphate suspension are converted.

If the phosphoric acid solution is too much, it may contaminate the equipment. Generally, the sample size for each analysis is 1 μL, and the maximum is not more than 2 μL.

Preferably, the loading size of the zirconium hydrogen phosphate suspension and the phosphoric acid solution used in each analysis are both 1 μL, and correspondingly, the concentration of the zirconium phosphate suspension is preferably 30 mg/mL.

Furthermore,

Step (2) when the thermal ionization mass spectrometer is used for determining, the W filament temperature is 1030-1130° C.

Furthermore,

In step (1), the amount of nickel sample is 200-1000 ng. high-precision Ni isotope analysis data can be obtained even for 200 ng sample size.

The analytical principle of the present invention is: according to the Langmuir-Kingdom empirical formula, the higher the work function of the metal ribbon, the higher the ionization efficiency of positive ions can be obtained. The present invention employs high-purity (purity higher than 99.8%) tungsten filament as the sample carrier, adds the zirconium hydrogen phosphate suspension as a high-sensitivity emitter when sample loading, and uses phosphoric acid solution as the auxiliary material to assist ionization efficiency. Significantly improve the ionization efficiency of nickel, which can indirectly increase the surface work function of the tungsten filament, thereby improving the ionization efficiency and analytical sensitivity of nickel, thereby reducing the amount of nickel samples.

The beneficial effects of the present invention are as follows:

1. Traditional ionization emitters include two types: silica gel+boric acid+aluminum nitrate, silica gel+phosphoric acid+aluminum chloride, with high-purity rhenium or tungsten filament as the sample carrier, because Ni has a high ionization potential (7.64 eV), It is difficult to be ionized during the thermal ionization mass spectrometry measurement. Traditional emitters cannot provide high-intensity and stable ion current signals for nickel isotopes with low sample amounts (<1000 ng), and thus cannot obtain satisfactory analytical precision for trace nickel samples.

Compared with the traditional emitters for nickel isotope analysis, the present invention provides a new type of zirconium hydrogen phosphate emitter instead of the traditional silica gel as the main emitter. The emitter adopts zirconium hydrogen phosphate suspension and phosphoric acid solution as the emitter. Using high-purity tungsten filament as the sample carrier to determine trace nickel isotopes, it can significantly improve the ionization efficiency of nickel and increase the analytical sensitivity by at least 5 times, thereby reducing the amount of sample. Traditional techniques require at least 1000 ng sample size each run, this technique only needs 200 ng sample size to obtain high-precision Ni isotope analysis data.

2. The loading blank of the zirconium hydrogen phosphate emitter provided by the present invention is very low, only ˜0.5 pg Ni each time, which does not cause contamination to small sample amount samples.

3. The nickel isotope analytical method for trace samples provided by the present invention has the advantages of high sensitivity, low cost, and convenient operation, shows the best analytical performance compared to the existing nickel isotope analytical technology by using thermal ionization mass spectrometry, and has strong application prospects.

### DETAILED DESCRIPTION OF THE PREFERRED EMBODIMENT

In order to better illustrate the content of the present invention, the following further verification of the present invention is carried out through specific embodiments.

It is hereby explained that the embodiments are only to describe the present invention more apparent, they are only a part of the present invention and cannot constitute any limitation to the present invention.

In the following examples, the selected source of raw materials is:

Premium grade pure zirconium hydrogen phosphate (purity: 99.9%, Sinopharm Chemical Reagent Co., Ltd.)

MOS pure hydrochloric acid (purified by sub-boiling distillation once purified, Sinopharm Chemical Reagent Co., Ltd)

Ultra-pure water (Millipore Simplicity type ultra-pure water system, outlet water conductivity 18.2 MΩ/cm)

Nickel isotope standard NIST 986 (National Institute of Standards and Materials, 1000 ∥g mL-1)

### Example 1

### 1. Preparation of Emitter

1) Weigh 150±0.2 mg of zirconium hydrogen phosphate powder into a teflon sample vial, then add 3 mL 2 mol/L hydrochloric acid, and then closed sample vial in a hot plate at 100-degree for 1 to 2 hours, shaking the sample vail frequently to clean the zirconium hydrogen phosphate powder, reducing the sample loading blank.

2) After the sample vial is cooled to room temperature, use a pipette to take out the upper hydrochloric acid solution, add 3 mL of high-purity deionized water, close the sample vial and shake the vial for 2 to 3 minutes, and let it stand for 3 minutes before use pipette to suck out the upper layer of solution.

3) Repeat the cleaning process of steps 1) and 2) 4 times, wash the high-purity zirconium hydrogen phosphate powder alternately with hydrochloric acid and deionized water, and the precipitate phase is the final used zirconium hydrogen phosphate powder.

4) Add 5 mL of high-purity deionized water to the zirconium hydrogen phosphate powder obtained in step 3) to prepare a zirconium hydrogen phosphate suspension with a concentration of 30 mg/mL for use as a nickel isotope ionization enhancement emitter.

### 2. Prepare Phosphoric Acid Solution

Add deionized water to saturated phosphoric acid (14.63 mol/L) in order to obtain 0.8 mol/L phosphoric acid solution, which is used as the auxiliary material of the emitter and is ready for use.

### 3. Sample Analysis Evaluation

The sample loading analysis evaluation is as follows:

1) Take 1 μL of 0.8 mol/L phosphoric acid solution and apply it on the surface of the high-purity tungsten filament, tune the filament current to evaporate the phosphoric acid solution to dryness first, and then take 1 μL of 30 mg/mL zirconium hydrogen phosphate suspension to cover the evaporated phosphoric acid coating. After the zirconium hydrogen phosphate suspension is evaporated to dryness, the international standard NIST 986 is loaded onto the surface of the tungsten filament, the current is tuned to 2.2 ampere, and the nickel sample is evaporated to dryness, and then the filament current is heated to a dull red glow and kept 3-5 seconds, then return the current to zero.

2) Install the sample magazine into the Triton Plus thermal ionization mass spectrometer, and use the Triton Plus thermal ionization mass spectrometer to determine international standard NIST 986 with loading different sample size. The filament temperature during the measurement is 1030 to 1130 degrees.

3) Use ⁶²Ni/⁵⁸Ni=0.05338858 for mass fractionation correction, the correction method is exponential law, 200 cycles of data are inquired, and ⁶⁰Ni/⁵⁸Ni results are recorded.

The concentration of phosphoric acid solution, the concentration of zirconium hydrogen phosphate suspension and the loading size of NIST986 in each example are listed in Table 1 and as follows:

TABLE 1
Data of the concentration of phosphoric acid solution,
the concentration of zirconium hydrogen phosphate suspension
and the loading size of NIST986 in Examples 1 to 5

| | Phosphoric | | Zirconium hydrogen | | |
|---|---|---|---|---|---|
| | acid solution | | phosphate suspension | | Loading size |
| | Concen- | Loading | Concen- | Loading | of NIST986 |
| Groups | tration | size | tration | size | (ng) |
| Example 1 | 0.8 mol/L | 1 μL | 30 mg/mL | 1 μL | 1000 |
| Example 2 | 0.8 mol/L | 1 μL | 30 mg/mL | 1 μL | 800 |
| Example 3 | 0.8 mol/L | 1 μL | 30 mg/mL | 1 μL | 500 |
| Example 4 | 0.8 mol/L | 1 μL | 30 mg/mL | 1 μL | 400 |
| Example 5 | 0.8 mol/L | 1 μL | 30 mg/mL | 1 μL | 200 |

The analytical results are as follows in Table 2-6:

TABLE 2
Analysis results of 1000 ng international
standard NIST 986 in Example 1

| Sample Numbers | ⁶⁰Ni/⁵⁸Ni | SE |
|---|---|---|
| NBS986 1000 ng 1 | 0.385267 | 0.000005 |
| NBS986 1000 ng 2 | 0.385257 | 0.000005 |
| NBS986 1000 ng 3 | 0.385278 | 0.000006 |
| NBS986 1000 ng 4 | 0.385267 | 0.000006 |
| NBS986 1000 ng 5 | 0.385259 | 0.000005 |
| NBS986 1000 ng 6 | 0.385275 | 0.000004 |
| NBS986 1000 ng 7 | 0.385283 | 0.000004 |
| NBS986 1000 ng 8 | 0.385259 | 0.000005 |
| Mean ± SD | 0.385268 | 0.000010 |

TABLE 3
Analysis results of 800 ng international
standard NIST 986 in Example 2

| Sample Numbers | ⁶⁰Ni/⁵⁸Ni | SE |
|---|---|---|
| NBS986 800 ng 1 | 0.385247 | 0.000005 |
| NBS986 800 ng 2 | 0.385251 | 0.000006 |
| NBS986 800 ng 3 | 0.385275 | 0.000004 |
| NBS986 800 ng 4 | 0.385282 | 0.000005 |
| NBS986 800 ng 5 | 0.385271 | 0.000004 |
| NBS986 800 ng 6 | 0.385277 | 0.000004 |
| NBS986 800 ng 7 | 0.385252 | 0.000005 |
| NBS986 800 ng 8 | 0.385255 | 0.000005 |
| Mean ± SD | 0.385264 | 0.000014 |

TABLE 4
Analysis results of 500 ng international
standard NIST 986 in Example 3

| Sample Numbers | ⁶⁰Ni/⁵⁸Ni | SE |
|---|---|---|
| NBS986 500 ng 1 | 0.385247 | 0.000006 |
| NBS986 500 ng 2 | 0.385251 | 0.000005 |
| NBS986 500 ng 3 | 0.385278 | 0.000006 |
| NBS986 500 ng 4 | 0.385261 | 0.000004 |
| NBS986 500 ng 5 | 0.385240 | 0.000006 |
| NBS986 500 ng 6 | 0.385261 | 0.000006 |
| NBS986 500 ng 7 | 0.385254 | 0.000006 |
| NBS986 500 ng 8 | 0.385234 | 0.000005 |
| Mean ± SD | 0.385253 | 0.000014 |

TABLE 5
Analysis results of 400 ng international
standard NIST 986 in Example 4

| Sample Numbers | ⁶⁰Ni/⁵⁸Ni | SE |
|---|---|---|
| NBS986 400 ng 1 | 0.385255 | 0.000006 |
| NBS986 400 ng 2 | 0.385247 | 0.000006 |
| NBS986 400 ng 3 | 0.385235 | 0.000006 |
| NBS986 400 ng 4 | 0.385252 | 0.000006 |
| NBS986 400 ng 5 | 0.385282 | 0.000008 |
| NBS986 400 ng 6 | 0.385221 | 0.000006 |
| NBS986 400 ng 7 | 0.385274 | 0.000006 |
| NBS986 400 ng 8 | 0.385250 | 0.000006 |
| Mean ± SD | 0.385252 | 0.000020 |

TABLE 6
Analysis results of the 200 ng international
standard NIST 986 in Example 5

| Sample Numbers | ⁶⁰Ni/⁵⁸Ni | SE |
|---|---|---|
| NBS986 200 ng 1 | 0.385288 | 0.000008 |
| NBS986 200 ng 2 | 0.385244 | 0.000007 |
| NBS986 200 ng 3 | 0.385257 | 0.000008 |
| NBS986 200 ng 4 | 0.385278 | 0.000007 |
| NBS986 200 ng 5 | 0.385226 | 0.000008 |
| NBS986 200 ng 6 | 0.385286 | 0.000006 |
| NBS986 200 ng 7 | 0.385268 | 0.000008 |
| NBS986 200 ng 8 | 0.385251 | 0.000008 |
| Mean ± SD | 0.385262 | 0.000022 |

TABLE 7
Signal intensity and emission duration of zirconium
phosphate for different sample amounts of nickel

| Sample | | Transmission |
|---|---|---|
| amount (ng) | ⁵⁸Ni(mV) | time (minutes) |
| 1000 | 1100~2300 | >25 |
| 800 | 900~1900 | >25 |
| 500 | 650~1400 | >22 |
| 400 | 500~1100 | >20 |
| 200 | 400~550 | >18 |

Tables 2 to 6 list the results of analyses of different sample sizes (1000 ng, 800 ng, 500 ng, 400 ng, 200 ng) of the international standard NIST 986 with 30 μg of zirconium phosphate suspension. The analytical results show that the internal precision of the ⁶⁰Ni/⁵⁸Ni ratio for all samples of 400˜1000 ng is better than ±0.000006 (1SE), which is within error from the reference value of NBS986 (⁶⁰Ni/⁵⁸Ni=0.385199±0.000108, 1SD) reported by Gramlich et al (1989) It is consistent within the analytical error, and the external precision of repeated analyses is better than ±0.000020 (1SD). Even for a sample size of 200 ng, the internal precision of the ⁶⁰Ni/⁵⁸Ni ratio of all samples is better than ±0.000009 (1SE), and the external precision of repeated analyses is better than ±0.000022. The external precision of different sample sizes in this work is 5-fold improvement than that of the existing TIMS technology (Gramlich et al Journal of Research of the National Institute of Standards and Technology, 1989, 94, 347-356). The sample size is significantly reduced from 5 μg reported by Gramlich et al.(1989) to 0.2 μg in this work.

It is obviously in Table 6 that a good external precision of (±0.000022) of ⁶⁰Ni/⁵⁸Ni ratio is obtained even for a 200 ng trace sample using zirconium hydrogen phosphate emitter, which demonstrates that the zirconium hydrogen phosphate emitter has extremely high sensitivity and high accuracy for Ni isotope analysis.

To further verify the ionization effect of the emitter provided by the present invention on the trace Ni sample, Table 7 lists the emission duration and emission intensity of different sample sizes. ⁵⁸Ni has the highest isotope abundance in the Ni isotope system, hence, the emission intensity of ⁵⁸Ni is used as a direct scale for sensitivity evaluation. Table 7 shows that the analytical method provided by the present invention, even for a 200 ng nickel sample, the intensity of ⁵⁸Ni can reach 400-550 mV, and the ⁵⁸Ni signal in this range can be stably emitted for more than 18 minutes, and the actual sample collection only requires 16 minutes (4 s integration, 200 cycles of data acquisition) and can obtain good internal precision better than 0.002% (RSE). This also shows that the emitter provided by the present invention has extremely high sensitivity and high accuracy for Ni isotope analysis.

One skilled in the art will understand that the embodiment of the present invention as shown in the drawings and described above is exemplary only and not intended to be limiting.

It will thus be seen that the objects of the present invention have been fully and effectively accomplished. Its embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. An emitter for trace samples of nickel isotope analysis, wherein:
the emitter is a zirconium hydrogen phosphate emitter; and
the zirconium hydrogen phosphate specifically comprises a zirconium hydrogen phosphate suspension and a phosphoric acid solution as an auxiliary material.

2. The emitter for trace samples of nickel isotope analysis, as recited in claim 1, wherein the zirconium hydrogen phosphate suspension is prepared by the following process: first alternately washing the high-purity zirconium hydrogen phosphate powder by hydrochloric acid and high-purity deionized water 3 to 4 times to reduce a sample loading blank; then adding deionized water to the treated zirconium hydrogen phosphate powder to prepare zirconium hydrogen phosphate suspension with a certain concentration.

3. The emitter for trace samples of nickel isotope analysis, as recited in claim 2, wherein a concentration of the zirconium hydrogen phosphate suspension is converted according to a dosage of the zirconium hydrogen phosphate emitter required for each analysis and a loading amount of the zirconium hydrogen phosphate suspension, specifically, the dosage of the high-purity zirconium hydrogen phosphate powder required for each analysis, It is 30±0.2 micrograms, and the loading size of the zirconium phosphate suspension is 1 to 3 μL, so the concentration of the zirconium hydrogen phosphate suspension is at a range of 10 to 30 mg/mL.

4. The emitter for trace samples of nickel isotope analysis, as recited in claim 2, wherein a purity of the high-purity zirconium phosphate powder is greater than 99.9%; and a particle size of the high-purity zirconium phosphate powder is less than 75 μm.

5. A method for preparing an emitter for trace samples of nickel isotope analysis, wherein the emitter is a zirconium hydrogen phosphate emitter; and the zirconium hydrogen phosphate emitter specifically comprises a zirconium hydrogen phosphate suspension and phosphoric acid solution as an auxiliary material;
(1) a preparation method of the zirconium hydrogen phosphate suspension comprising steps of:
S1: pre-treating zirconium hydrogen phosphate, comprising:
S11: weighing the high-purity zirconium hydrogen phosphate powder and placing in a teflon vial, adding hydrochloric acid in proportion, closing the teflon vial and placing on a hot plate at 80-100 degrees for 1 to 2 hours, shaking the vial during heating time, and cleaning the zirconium hydrogen phosphate with hydrochloric acid powder to reduce the loading blank;
S12: then, cooling to room temperature, taking out an upper layer of hydrochloric acid solution, adding high-purity deionized water, closing again and shaking the container for 3 to 4 minutes, standing still for layering, and sucking out the supernatant again;
S13: repeating the cleaning process of steps S11 and S12 for 3 to 4 times, and finally obtaining a precipitation phase, which is the pretreated zirconium hydrogen phosphate;
S2: weighing the zirconium hydrogen phosphate pretreated in step S13 and adding deionized water to prepare a zirconium hydrogen phosphate suspension of a certain concentration; wherein the concentration of the zirconium hydrogen phosphate suspension is based on the dose of zirconium hydrogen phosphate emitter required for each analysis and the loading volume of zirconium hydrogen phosphate suspension; specifically, the dosage of high-purity zirconium hydrogen phosphate powder required for each analysis is 30±0.2 μg, and the loading volume of zirconium hydrogen phosphate suspension is 1-3 μL; the concentration of the zirconium hydrogen phosphate suspension is 10-30 mg/mL;
(2) preparing phosphoric acid solution weighing the concentrated phosphoric acid solution, adding deionized water in proportion to prepare a phosphoric acid solution with a concentration at a range of 0.8-1.0 mol/L.

6. The method as recited in claim 5, wherein in step S11, a concentration of hydrochloric acid for cleaning is 2 to 4 mol/L, and an amount of hydrochloric acid for cleaning is 1 ml per (30±0.2 mg) high-purity zirconium hydrogen phosphate powder;
in step S12, an amount of high-purity deionized water used for cleaning is 1 ml per (30±0.2 mg) high-purity zirconium hydrogen phosphate powder.

7. A method for determining nickel isotopes of trace samples, which is characterized in adopting zirconium hydrogen phosphate suspension as a high-sensitivity emitter to enhance the ionization efficiency of nickel samples, and meanwhile adopting phosphoric acid solution to assist ionization, and adopting high-purity tungsten filament as a sample carrier to determine nickel isotopes.

8. The method for determining nickel isotopes in trace samples as recited in claim 7, which is characterized in specifically comprising steps of:
(1) taking an appropriate amount of the emitter composed of zirconium hydrogen phosphate suspension and phosphoric acid solution and coating on the surface of the high-purity tungsten filament; after the emitter evaporates to dryness, loading the nickel sample on the surface of the filament, and tuning the current to 2.2 amperes and evaporating to dryness, then continuing to increase the filament current until the filament turns a dull red glow for 3 to 5 seconds, and then returning the current to zero;
(2) installing the sample magazine with nickel sample into the thermal ionization mass spectrometer, and using the thermal ionization mass spectrometer to obtain high-precision nickel isotope data; wherein the temperature of the filament is at a range of 1030-1130° C. during the measurement.

9. The method as recited in claim 8, wherein step (1) The coating process of the emitter is as follows:
taking 1-2 μL of phosphoric acid solution with a concentration of 0.8-1.0 mol/L and applying on a surface of high-purity tungsten filament, tuning the filament current to evaporate the phosphoric acid solution to dryness, and then taking 1-3 μL of a certain concentration of zirconium hydrogen phosphate suspension to cover on the evaporated phosphoric acid coating, after the zirconium hydrogen phosphate suspension is evaporated to dryness, loading the nickel sample on the surface of the W filament.

10. The method, as recited in claim 8, wherein in step (1), an amount of nickel sample is at a range of 200-1000 ng.
